(19) United States
(12) Patent Application Publication
(10) Pub. No.: US 2021/0153247 A1
(43) Pub. Date: May 20, 2021

(54) RANDOM ACCESS METHOD AND TERMINAL DEVICE

(71) Applicant: GUANGDONG OPPO MOBILE TELECOMMUNICATIONS CORP., LTD., Dongguan (CN)

(72) Inventors: CONG SHI, Dongguan (CN); SHUKUN WANG, Dongguan (CN); NING YANG, Dongguan (CN); QIANXI LU, Dongguan (CN); XIN YOU, Dongguan (CN)

(21) Appl. No.: 17/160,834

(22) Filed: Jan. 28, 2021

Related U.S. Application Data
(63) Continuation of application No. PCT/CN2019/082138, filed on Apr. 10, 2019.

(30) Foreign Application Priority Data
Jul. 30, 2018 (CN) 201810852639.0

(51) Int. Cl. H04W 74/00; H04W 74/08; H04W 80/02; H04W 72/04

(52) U.S. Cl. CPC H04W 74/008; H04W 74/0833; H04W 72/0453; H04W 72/0446; H04W 80/02

(57) ABSTRACT

A random access method and related device and a terminal device are provided. The method includes operations as follows. A random access response message sent by a network side is received. Whether a random access response in the random access response message is for the terminal device is determined based on indication information in the random access response message. The indication information may at least indicate different types of random access responses or indicate different types of random access processes.

### CROSS-REFERENCE TO RELATED APPLICATIONS

This is a continuation application of International Patent Application No. PCT/CN2019/082138, filed on Apr. 10, 2019, which claims priority to Chinese Patent Application No. 201810852639.0, filed on Jul. 30, 2018, the contents of which are hereby incorporated by reference in their entireties.

### BACKGROUND

In New Radio (NR), two random access manners are mainly supported, i.e., a contention-based random access manner and a contention-free random access manner. At present, random access processes may include 4-step access and 2-step access. Therefore, a terminal device executing 2-step random access (RACH) and a terminal device executing 4-step RACH may coexist in a system, which results in confliction between the two coexisting terminal devices.

### SUMMARY

The disclosure relates to the technical field of information processing, and particularly to a random access method and a terminal device, in order for solving the foregoing technical problem.

A first aspect of the embodiments provides a random access method, which may be applied to a terminal device and include the following operations.

A random access response message sent by a network side is received.

Whether a random access response in the random access response message is responsive to the terminal device is determined based on indication information in the random access response message.

The indication information may at least indicate different types of random access responses or indicate different types of random access processes.

A second aspect of the embodiments provides a terminal device, which may include a processor, a transceiver and a memory. The memory may be configured to store a computer program, and the processor may be configured to call and run the computer program stored in the memory to control the transceiver to receive a random access response message sent by a network side. The processor is configured to call and run the computer program stored in the memory to determine whether a random access response in the random access response message is responsive to the terminal device based on indication information in the random access response message. The indication information is able to at least indicate different types of random access responses or indicate different types of random access processes.

### BRIEF DESCRIPTION OF THE DRAWINGS

FIG. 1 is a first architecture diagram of a communication system according to an embodiment of the disclosure.

FIG. 2 is a flowchart of a random access method according to an embodiment of the disclosure.

FIG. 3 is a schematic diagram of information content of an RAR.

FIG. 4 is a schematic diagram of information content of an RAR.

FIG. 5 is a schematic diagram of information content of an RAR.

FIG. 6 is a schematic diagram of information content of an RAR.

FIG. 7 is a flowchart of random access processing.

FIG. 8 is a composition structure diagram of a terminal device according to an embodiment of the disclosure.

FIG. 9 is a composition structure diagram of a communication device according to an embodiment of the disclosure.

FIG. 10 is a schematic block diagram of a chip according to an embodiment of the disclosure.

FIG. 11 is a second architecture diagram of a communication system according to an embodiment of the disclosure.

### DETAILED DESCRIPTION

The technical solutions in the embodiments of the disclosure are described below in combination with the drawings in the embodiments of the disclosure. Apparently, the described embodiments are only a part rather than all of the embodiments of the disclosure. All other embodiments obtained by those skilled in the art on the basis of the embodiments in the disclosure without paying creative work fall within the scope of protection of the disclosure.

The technical solutions of the embodiments of the disclosure may be applied to various communication systems such as a Global System of Mobile Communication (GSM) system, a Code Division Multiple Access (CDMA) system, a Wideband Code Division Multiple Access (WCDMA) system, a General Packet Radio Service (GPRS), a Long Term Evolution (LTE) system, an LTE Frequency Division Duplex (FDD) system, LTE Time Division Duplex (TDD), a Universal Mobile Telecommunication System (UMTS), a Worldwide Interoperability for Microwave Access (WiMAX) communication system and a 5th-Generation (5G) system.

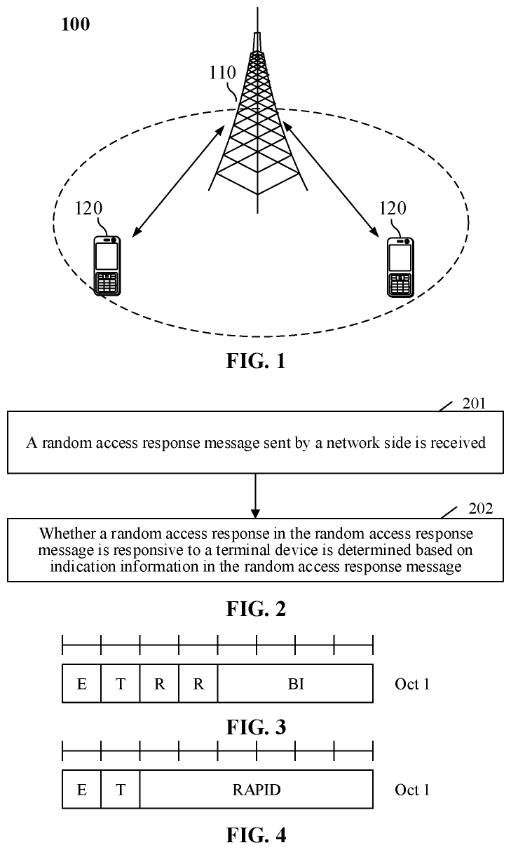

Exemplarily, a communication system 100 in the embodiments of the disclosure may be illustrated in FIG. 1 and may include a network device 110 which may be a device communicating with a terminal device 120 (a communication terminal or a terminal). The network device 110 may provide communication coverage for a particular geographical area and communicate with a terminal device located in the coverage. Optionally, the network device 110 may be a base station (a Base Transceiver Station (BTS)) in a GSM system or a CDMA system, a base station (a NodeB (NB)) in a WCDMA system, an evolutional base station (an Evolutional Node B (eNB or eNodeB)) in an LTE system, a wireless controller in a Cloud Radio Access Network (CRAN). Alternatively, the network device may be a mobile exchange center, a relay station, an access point, an on-board device, a wearable device, a hub, a switch, a bridge, a router, a network side device in a 5G network, a network device in a future evolutional Public Land Mobile Network (PLMN) or the like.

The communication system 100 further includes at least one terminal device 120 in the coverage of the network device 110. The terminal device used herein includes but is not limited to be connected via a wired line such as a Public Switched Telephone Network (PSTN), a Digital Subscriber Line (DSL), a digital cable, a direct cable, and/or via another data connection or network, and/or via a wireless interface such as a cellular network, a wireless local area network (WLAN), a digital television network like a Digital Video Broadcasting-Handheld (DVB-H) network, a satellite network, an Amplitude Modulation-Frequency Modulation (AM-FM) broadcasting transmitter, and/or via a device, which is configured to receive/send a communication signal, of another terminal device and/or an Internet of Things (IoT) device. The terminal device configured to communicate through the wireless interface may be referred to as “a wireless communication terminal”, “a wireless terminal” or “a mobile terminal”. Examples of a mobile terminal include, but not limited to, a satellite or cellular telephone, a personal communication system (PCS) terminal capable of combining a cellular radio telephone and data processing, faxing and data communication capabilities, a personal digital assistant (PDA) capable of including a radio telephone, a pager, Internet/intranet access, a Web browser, a notepad, a calendar and/or a Global Positioning System (GPS) receiver, and a conventional laptop and/or palmtop receiver or another electronic device including a radio telephone transceiver. The terminal device may refer to an access terminal, User Equipment (UE), a user unit, a user station, a mobile station, a mobile radio station, a remote station, a remote terminal, a mobile device, a user terminal, a terminal, a wireless communication device, a user agent or a user device. The access terminal may be a cell phone, a cordless phone, a Session Initiation Protocol (SIP) phone, a Wireless Local Loop (WLL) station, a PDA, a handheld device having a wireless communication function, a computing device, another processing device connected to a wireless modem, an on-board device, a wearable device, a terminal device in the 5G network, a terminal device in the future evolved PLMN or the like.

Optionally, Device to Device (D2D) communication may be performed between the terminal devices 120.

Optionally, the 5G system or the 5G network may also be called a New Radio (NR) system or an NR network.

One network device and two terminals are exemplarily shown in FIG. 1. Optionally, the communication system 100 may include multiple network devices, and each of the network devices may have other number of terminals in coverage thereof, which is not limited in the embodiments of the disclosure.

Optionally, the communication system 100 may further include another network entity such as a network controller and a mobility management entity, which is not limited in the embodiments of the disclosure.

It is to be understood that a device having a communication function in the network/system in the embodiments of the disclosure may be called a communication device. Taking the communication system 100 shown in FIG. 1 as an example, the communication device may include the network device 110 and terminal 120 having the communication function, and the network device 110 and the terminal 120 may be the specific devices mentioned above and will not be elaborated herein. The communication device may further include other devices in the communication system 100, for example, other network entities like a network controller and a mobility management entity, which is not limited in the embodiments of the disclosure.

It should be understood that the terms “system” and “network” are often used interchangeably herein. The term “and/or” herein only represent an association relationship of associated objects, which means that there may be three relationships. For example, A and/or B can mean: only A exists, both A and B exist, and only B exists. In addition, the character “/” herein generally indicates that there is an “or” relationship between two associated objects.

As shown in FIG. 2, the embodiments of the disclosure provide a random access method, which is applied to a terminal device and includes the following operations.

In 201, a random access response message sent by a network side is received.

In 202, whether a random access response in the random access response message is responsive to the terminal device is determined based on indication information in the random access response message.

The indication information may at least indicate different types of random access responses or indicate different types of random access processes.

It should also be pointed out that different types of random access responses correspond to different types of random access processes.

The following scenarios may be provided in the embodiment: a first scenario in a first manner and a second manner, a second scenario and a third scenario.

First Manner of the First Scenario

Regarding a condition that the indication information only includes first indication information, reference is made to the following descriptions.

The indication information includes the first indication information that is a Random Access Preamble Identifier (RAPID) in the random access response message. The RAPID is configured to indicate different types of random access processes or configured to indicate different types of random access responses.

In the scenario, the RAPID is different from an RAPID defined in the conventional art, and may be configured to indicate a random access process type or indicate different random access process responses. A specific processing manner is described as follows.

RAPIDs are grouped, and preambles are grouped. For example, there may be a group A and a group B. If a UE selects a 2-step random access process, when a Message 1 (msg1) is sent, a random access preamble is selected from the group A. If the UE selects a 4-step random access process, when the msg1 is sent, the preamble is selected from the group B.

Second Manner of the First Scenario

Regarding a condition that the indication information only includes first indication information, reference is made to the following descriptions.

The indication information includes the first indication information that is a Random Access Preamble Identifier (RAPID) in the random access response message. The RAPID is configured to indicate different types of random access processes or configured to indicate different types of random access responses.

In the scenario, the RAPID is different from an RAPID defined in the conventional art and may be configured to indicate a random access process type or indicate different random access process responses.

A difference of the second manner from the first manner is that, in the second manner, preambles may not be grouped, and it is only defined that different Physical Random Access Channel (PRACH) resources are adopted for a 2-step random access process and a 4-step random access process.

Specifically, PRACH resources corresponding to the 2-step random access process and the 4-step random access process may be grouped, but preambles of the PRACH resources may be identical. Of course, it is also to be understood that the PRACHs may not be grouped and it is only necessary to set that different types of random access processes correspond to different PRACH resources.

In such case, different types of RACH processes may be distinguished through the preambles. This is because UEs adopting different RACH processes may calculate different Random Access Radio Network Temporary Identities (RA-RNTIs) (the RA-RNTIs are calculated based on time-frequency positions of the PRACH resources) due to the grouping for the PRACH resources. Due to different RA-RNTIs, different RAR messages may be obtained.

In the second scenario, a random access process type or a random access response type is indicated through second indication information.

Specifically, the indication information further includes the second indication information configured to indicate different types of random access processes or configured to indicate different types of random access responses.

A difference from the second scenario from the first scenario is that, in the second scenario, the RAPID in the first indication information may not indicate the random access process type or the random access response type. That is, the first indication information only includes an ordinary RAPID.

It is to be noted that the ordinary RAPID in the second scenario is different from the RAPID in the first scenario, and the ordinary RAPID in the second scenario refers to that the PRACH resources may not be distinguished for different types of random access processes, that is, the PRACH resources, i.e., PRACH time-domain resources and/or code resources, are shared resources.

The random access process type and the random access response type are indicated through the second indication information.

Third Scenario

In this scenario, the indication information includes only second indication information. In this case, the second indication information may include a RAPID and an indication for the random access process type and the random access response type. That is, in this scenario, no first indication information may be included, and all information is indicated through the second indication information.

Based on the abovementioned scenario, the second indication information is described below.

The second indication information may be an explicit indication manner.

For example, the second indication information may be a first indication field in the random access response. The first indication field may indicate the random access process type.

The second indication information may be a second indication field in a Media Access Control (MAC) subheader corresponding to the random access response. The second indication information is an indication field in the MAC subheader corresponding to the random access response, and the indication field may indicate the random access process type.

The second indication information may be an implicit indication manner.

For example, the second indication information is a third indication field in the MAC subheader corresponding to the random access response, the third indication field is configured to indicate an random access response length, and different random access response lengths correspond to different types of random access processes, or different random access response lengths correspond to different types of random access responses.

A first random access response length corresponds to a 2-step random access process type, and a second random access response length corresponds to a 4-step random access process type.

That is, a domain in the MAC subheader corresponding to the random access response indicates the random access response length, and different lengths represent different random access processes.

For example, two random access response lengths may be defined in the system: a length a corresponding to the 2-step random access process, and a length b corresponding to the 4-step random access process.

With respect to how to determine whether the random access response in the random access response message is responsive to the terminal device based on the above indication information, one of the following manners may be used.

First Manner

When the indication information only includes the first indication information, if it is determined according to the RAPID in the first indication information that the random access process type is consistent with a random access process type selected by the terminal device, it is determined that the random access response in the random access response message is a response for the terminal device.

This manner corresponds to the above first scenario. In the first scenario, only the first indication information is included, and the random access process type indicated by the first indication information is determined through correspondences between the RAPIDs and different random access process types. This manner may correspond to both the first and second manners for the first scenario. Different RAPIDs correspond to different PRACH resources, that is, the PRACH resources may be grouped and different RAPIDs correspond to different PRACH resource groups. Furthermore, the PRACH resources of different groups also correspond to different RACH process types. Therefore, different random access process types are distinguished based on the RAPID in the first indication information.

Furthermore, it may be determined that the random access response in the random access response message is responsive to the terminal device only when the random access process type in the first indication information is the same as the random access process type selected by the terminal device.

It is also to be understood that the random access response message may at least include the indication information and the random access response.

Second Manner

When the indication information only includes the first indication information, if it is determined according to the RAPID in the first indication information that the random access response type corresponds to the random access process type selected by the terminal device, it is determined that the random access response in the random access response message is a response for the terminal device.

This manner corresponds to the above first scenario. In the first scenario, only the first indication information is included, and the random access process type indicated by the first indication information is determined through correspondences between the RAPIDs and different random access process types. This manner may correspond to both manners for the first scenario. Different RAPIDs correspond to different PRACH resources, that is, the PRACH resources may be grouped and different RAPIDs correspond to different PRACH resource groups. Furthermore, the PRACH resources of different groups also correspond to different random access process types. Therefore, different random access process types or different random access response types are distinguished based on the RAPIDs in the first indication information.

Furthermore, it may be determined that the random access response in the random access response message is responsive to the terminal device only when the random access response type in the first indication information corresponds to the random access process type selected by the terminal device.

Correspondences between different random access process types and different random access response types may be pre-configured by the system. The correspondences may be pre-configured to the terminal device by the network side, to ensure that configurations of the terminal device and the network side are identical.

It is also to be understood that the random access response message may at least include the indication information and the random access response.

Third Manner

When the RAPID in the first indication information is consistent with a RAPID sent by the terminal device, and the random access process type indicated by the second indication information is consistent with the random access process type selected by the terminal device, it is determined that the random access response in the random access response message is a response for the terminal device.

This manner corresponds to the above second scenario. That is, the RAPID in the first indication information is not configured to distinguish the random access process types and the random access response types, and is only configured to indicate a preamble Identifier (ID). In such case, it may be determined that the random access response in the random access response message is responsive to the terminal device only when the RAPIDs are consistent and the random access process type in the second indication information is the same as the random access process type selected by the terminal device.

Fourth Manner

When the RAPID in the first indication information is consistent with a RAPID sent by the terminal device, and the random access response type indicated by the second indication information is consistent with the random access process type selected by the terminal device, it is determined that the random access response in the random access response message is a response for the terminal device.

This manner corresponds to the above second scenario. That is, the RAPID in the first indication information is not configured to distinguish the random access process types and the random access response types, and is only configured to indicate a preamble Identifier (ID). In such case, it may be determined that the random access response in the random access response message is responsive to the terminal device only when the RAPIDs are consistent and the random access response type in the second indication information corresponds to the random access process type selected by the terminal device.

Fifth Manner

When the indication information only includes the second indication information, if the RAPID acquired from the second indication information is consistent with an RAPID sent by the terminal device and the random access process type indicated by the second indication information is consistent with the random access process type selected by the terminal device, it is determined that the random access response in the random access response message is a response for the terminal device.

This manner corresponds to the third scenario. That is, only the second indication information is sent, and random access process types or random access response types may not be distinguished through the RAPIDs. In such case, it may be determined whether the random access response is responsive to the terminal device when it is determined that the RAPID is the same as the random access preamble, and the random access process type is the same as that selected by the terminal.

Sixth Manner

When the indication information only includes the second indication information, the RAPID acquired from the second indication information is consistent with the RAPID sent by the terminal device and the random access response type indicated by the second indication information corresponds to the random access process type selected by the terminal device, it is determined that the random access response in the random access response message is a response for the terminal device.

This manner corresponds to the third scenario. That is, only the second indication information is sent, and the random access process types or random access response types may not be distinguished through the RAPIDs. In such case, it may be determined whether the random access response is responsive to the terminal device when it is determined that the RAPID is the same as the random access preamble, and the random access response type corresponds to the random access process type selected by the terminal.

The random access preamble is sent by the terminal device on a pre-configured random access resource, and selected by the terminal device from at least two random access preambles.

The random access process type includes one of the 2-step random access process and the 4-step random access process.

The 4-step random access process includes the following specific steps 1 to 4.

In step 1, the terminal selects a PRACH resource (a time-frequency resource and a code-domain resource).

The terminal sends a selected preamble on the selected PRACH time-frequency resource. A base station may estimate Uplink (UL) timing and a grant size required for transmitting a Message 3 (msg3) by the terminal based on the preamble.

In step 2, the network sends an RAR to the terminal.

The terminal, after sending a first message (msg1), starts an RAR window and monitors a PDCCH in the window. The PDCCH is a PDCCH scrambled by an RA-RNTI. The RA-RNTI is calculated as follows:

RA-RNTI=1+s_id+14×t_id+14×80×f_id+14×80×8×ul_carrier_id.

That is, the RA-RNTI is related to the PRACH time-frequency resource selected by the UE.

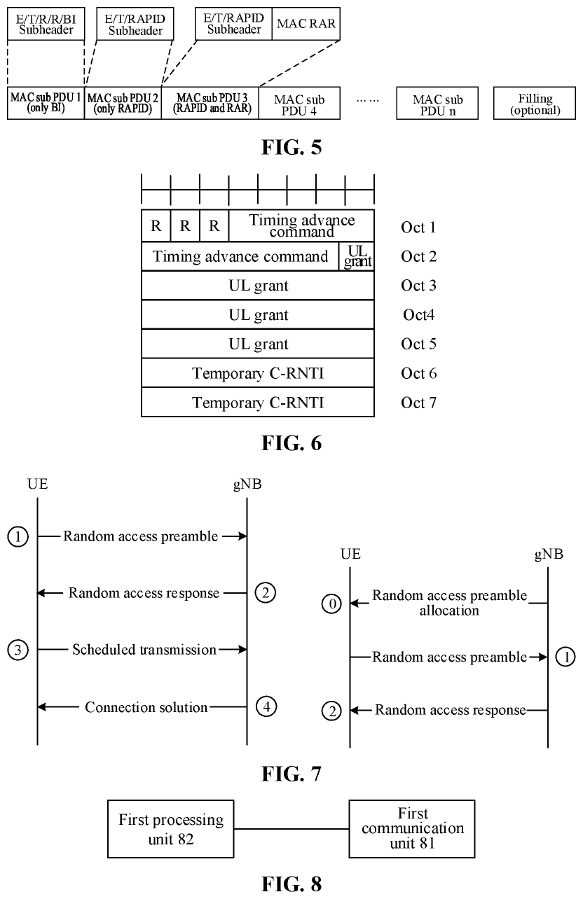

After the PDCCH scrambled by the RA-RNTI is successfully monitored, the terminal may obtain a Physical Downlink Shared Channel (PDSCH), scheduled by the PDCCH, in which the RAR is included. A format of the RAR is shown in FIGS. 3 to 6. A subheader of the RAR includes: a Back Indicator (BI) configured to indicate back-off time for retransmission of the msg1; and a RAPID configured to indicate a preamble index received by the network. A payload of the RAR includes a Tracking Area Code (TAC) configured to regulate the UL timing, a UL grant configured to indicate an uplink resource scheduling a third message and a Temporary Cell Radio Network Temporary Identity (C-RNTI) (TC-RNTI) configured to scramble a PDCCH for a fourth message 4 (initial access).

In step 3, the terminal transmits an RRC message on the scheduled resource.

The msg3 is mainly configured to notify the network of an event which triggers the RACH process. For example, in an initial RACH process, the msg3 may carry a UE ID and an establishment cause. In Radio Resource Control (RRC) re-establishment, the msg3 may carry a connected-state UE ID and an establishment cause.

In addition, a contention conflict for the ID carried in the msg3 is resolved in step 4.

In step 4, the contention conflict is resolved.

The msg4 has two functions: one is to solve the contention conflict, and the other is to transmit an RRC configuration message to the terminal.

Specifically, the contention conflict is resolved in the following manners.

In a first manner, if the UE carries a C-RNTI in step 3, the fourth message is scheduled by the PDCCH scrambled by the C-RNTI.

In a second manner, if the UE does not carry the C-RNTI in step 3, for example, in initial access, the fourth message is scheduled by the PDCCH scrambled by the TC-RNTI. The conflict is resolved in a manner that the UE receives the PDSCH for the fourth message and matches a Common Control Channel (CCCH) Service Data Unit (SDU) in the PDSCH.

The message contents carried in each message for 4-step RACH are shown in the following table.

| | Msg1 | Msg2 | Msg3 | Msg4 |
|---|---|---|---|---|
| Initial access | Random access | RAR-RNTI | UE ID (48 bit | TC-RNTI |
| | preamble | addressed | 5G-S-TMSI); | addressed |
| | | PDCCH; | Establishment | PDCCH; |
| | | PDSCH; | cause (4 bit) | CCCH SDU in |
| | | BI (optional); | | the PDSCH |
| | | RAPID; | | scheduled by |
| | | TA; | | the PDCCH |
| RRC re- | | UL grant; | Re- | C-RNTI |
| establishment | | TC-RNTI | establishment | addressed |
| | | | UE ID; | PDCCH; |
| | | | C-RNTI; | CCCH SDU in |
| | | | PCI (of the | the PDSCH |
| | | | primary cell); | scheduled by |
| | | | Short MAC I; | the PDCCH |
| | | | Reestablishment | |
| | | | cause | |
| Handover | | | N/A* | N/A* |
| RRC resume | | | Resume ID | C-RNTI |
| | | | Short MAC I | addressed |
| | | | RRC resume | PDCCH; |
| | | | cause | CCCH SDU in |
| | | | | the PDSCH |
| | | | | scheduled by |
| | | | | the PDCCH |
| SI request | | RA-RNTI | N/A | N/A |
| | | addressed | | |
| | | PDCCH; | | |
| | | RAR only | | |
| | | includes | | |
| | | RAPID | | |
| BFR | | C-RNTI | N/A | N/A |
| | | addressed | | |
| | | PDCCH | | |

In the 2-step random access process, msg1+msg3 in 4-step RACH may be transmitted in msg1+, and msg2+msg4 in 4-step RACH may be transmitted in msg2+.

The terminal device initiates different random access processes on different random access resources.

In NR, two random access manners are mainly supported, i.e., a contention-based random access manner and a contention-free random access manner, as shown in FIG. 7.

The random access process may be triggered by the following events: initial access in an RRC idle state; an RRC connection re-establishment procedure; handover; UL or downlink data arrival in an RRC connected state when a UL synchronization state is a non-synchronized state; transmission in an RRC non-activated state; and a request for other System Information (SI).

The random access resources have correspondences with random access process types.

The random access resources include a time-frequency resource and/or a random access preamble.

It can be seen that, with the above solution, whether the random access response for the terminal device is received may be determined through the indication information in the random access response message sent to the terminal device by the network side. A random access type or a random access process type may be indicated in the indication information. Therefore, it is ensured that the terminal device can correctly receive the random access response conforming to a random access process type of the terminal device in a system where multiple types of random access processes exist.

The embodiments of the disclosure provide a random access method, which is applied to a network device and includes the following operation.

A random access response message is sent to a terminal device.

The random access response message includes indication information, and the indication information may at least indicate different types of random access responses or indicate different types of random access processes.

It should also be pointed out that different types of random access responses correspond to different types of random access processes.

The following scenarios may be provided in the embodiment: a first scenario in a first manner and a second manner, a second scenario and a third scenario.

First Manner of the First Scenario

Regarding a condition that the indication information only includes first indication information, reference is made to the following descriptions.

The indication information includes the first indication information that is a Random Access Preamble Identifier (RAPID) in the random access response message. The RAPID is configured to indicate different types of random access processes or configured to indicate different types of random access responses.

In the scenario, the RAPID is different from an RAPID defined in the conventional art, and may be configured to indicate a random access process type or indicate different random access process responses. A specific processing manner is described as follows.

RAPIDs are grouped, and preambles are grouped. For example, there may be a group A and a group B. If a UE selects a 2-step random access process, when a Message 1 (msg1) is sent, a random access preamble is selected from the group A. If the UE selects a 4-step random access process, when the msg1 is sent, the preamble is selected from the group B.

Second Manner of the First Scenario

Regarding a condition that the indication information only includes first indication information, reference is made to the following descriptions.

The indication information includes the first indication information that is a Random Access Preamble Identifier (RAPID) in the random access response message. The RAPID is configured to indicate different types of random access processes or configured to indicate different types of random access responses.

In the scenario, the RAPID is different from an RAPID defined in the conventional art and may be configured to indicate a random access process type or indicate different random access process responses.

A difference of the second manner from the first manner is that, in the second manner, preambles may not be grouped, and it is only defined that different Physical Random Access Channel (PRACH) resources are adopted for the 2-step random access process and the 4-step random access process.

Specifically, PRACH resources corresponding to the 2-step random access process and the 4-step random access process may be grouped, but preambles of the PRACH resources may be identical. Of course, it is also to be understood that the PRACHs may not be grouped and it is only necessary to set that different types of random access processes correspond to different PRACH resources.

In such case, different types of RACH processes may be distinguished through the preambles. This is because UEs adopting different RACH processes may calculate different Random Access Radio Network Temporary Identities (RA-RNTIs) (the RA-RNTIs are calculated based on time-frequency positions of the PRACH resources) due to the grouping for the PRACH resources. Due to different RA-RNTIs, different RAR messages may be obtained.

In the second scenario, a random access process type or a random access response type is indicated through second indication information.

Specifically, the indication information further includes the second indication information configured to indicate different types of random access processes or configured to indicate different types of random access responses.

A difference from the second scenario from the first scenario is that, in the second scenario, the RAPID in the first indication information may not indicate the random access process type or the random access response type. That is, the first indication information only includes an ordinary RAPID.

It is to be noted that the ordinary RAPID in the second scenario is different from the RAPID in the first scenario, and the ordinary RAPID in the second scenario refers to that the PRACH resources may not be distinguished for different types of random access processes, that is, the PRACH resources, i.e., PRACH time-domain resources and/or code resources, are shared resources.

Third Scenario

In this scenario, the indication information includes only second indication information. In this case, the second indication information may include a RAPID and an indication for the random access process type and the random access response type. That is, in this scenario, the first indication information may not be included, and all information is indicated through the second indication information.

Based on the abovementioned scenario, the second indication information is described below.

The second indication information may be an explicit indication manner.

For example, the second indication information may be a first indication field in the random access response. The first indication field may indicate the random access process type.

The second indication information may be a second indication field in a Media Access Control (MAC) subheader corresponding to the random access response. The second indication information is an indication field in the MAC subheader corresponding to the random access response, and the indication field may indicate the random access process type.

The second indication information may be an implicit indication manner.

For example, the second indication information is a third indication field in the MAC subheader corresponding to the random access response, the third indication field is configured to indicate an random access response length, and different random access response lengths correspond to different types of random access processes, or different random access response lengths correspond to different types of random access responses.

A first random access response length corresponds to a 2-step random access process type, and a second random access response length corresponds to a 4-step random access process type.

That is, a domain in the MAC subheader corresponding to the random access response indicates the random access response length, and different lengths represent different random access processes.

For example, two random access response lengths may be defined in the system: a length a corresponding to the 2-step random access process, and a length b corresponding to the 4-step random access process.

The network side may further receive different random access processes initiated by the terminal device on different random access resources.

The random access resources have correspondences a random access process types.

The random access resources include a time-frequency resource and/or a random access preamble.

It can be seen that, with the above solution, whether a random access response for the terminal device is received or not may be determined through the indication information in the random access response message sent to the terminal device by the network side, and a random access response type or a random access process type may be indicated in the indication information. Therefore, it is ensured that the terminal device can correctly receive the random access response conforming to a random access process type of the terminal device in a system where multiple types of random access processes exist.

As shown in FIG. 8, the embodiments of the disclosure provide a terminal device, which includes a first communication unit 81 and a first processing unit 82.

The first communication unit 81 is configured to receive a random access response message sent by a network side.

The first processing unit 82 is configured to determine whether a random access response in the random access response message is responsive to the terminal device based on indication information in the random access response message.

The indication information may at least indicate different types of random access responses or indicate different types of random access processes.

It should also be pointed out that different types of random access responses correspond to different types of random access processes.

The following scenarios may be provided in the embodiment: a first scenario in a first manner and a second manner, a second scenario and a third scenario.

First Manner of the First Scenario

Regarding a condition that the indication information only includes first indication information, reference is made to the following descriptions.

The indication information includes the first indication information that is a Random Access Preamble Identifier (RAPID) in the random access response message. The RAPID is configured to indicate different types of random access processes or configured to indicate different types of random access responses.

In the scenario, the RAPID is different from an RAPID defined in the conventional art, and may be configured to indicate a random access process type or indicate different random access process responses. A specific processing manner is described as follows.

RAPIDs are grouped, and preambles are grouped. For example, there may be a group A and a group B. If a UE selects a 2-step random access process, when a Message 1 (msg1) is sent, a random access preamble is selected from the group A. If the UE selects a 4-step random access process, when the msg1 is sent, the preamble is selected from the group B.

Second Manner of the First Scenario

Regarding a condition that the indication information only includes first indication information, reference is made to the following descriptions.

The indication information includes the first indication information that is a

Random Access Preamble Identifier (RAPID) in the random access response message. The RAPID is configured to indicate different types of random access processes or configured to indicate different types of random access responses.

In the scenario, the RAPID is different from an RAPID defined in the conventional art and may be configured to indicate a random access process type or indicate different random access process responses.

A difference of the second manner from the first manner is that, in the second manner, preambles may not be grouped, and it is only defined that different Physical Random Access Channel (PRACH) resources are adopted for a 2-step random access process and a 4-step random access process.

Specifically, PRACH resources corresponding to the 2-step random access process and the 4-step random access process may be grouped, but preambles of the PRACH resources may be identical. Of course, it is also to be understood that the PRACHs may not be grouped and it is only necessary to set that different types of random access processes correspond to different PRACH resources.

In such case, different types of RACH processes may be distinguished through the preambles. This is because UEs adopting different RACH processes may calculate different Random Access Radio Network Temporary Identities (RA-RNTIs) (the RA-RNTIs are calculated based on time-frequency positions of the PRACH resources) due to the grouping for the PRACH resources. Due to different RA-RNTIs, different RAR messages may be obtained.

In the second scenario, a random access process type or a random access response type is indicated through second indication information.

Specifically, the indication information further includes the second indication information configured to indicate different types of random access processes or configured to indicate different types of random access responses.

A difference from the second scenario from the first scenario is that, in the second scenario, the RAPID in the first indication information may not indicate the random access process type or the random access response type. That is, the first indication information only includes an ordinary RAPID.

It is to be noted that the ordinary RAPID in the second scenario is different from the RAPID in the first scenario, and the ordinary RAPID in the second scenario refers to that the PRACH resources may not be distinguished for different types of random access processes, that is, the PRACH resources, i.e., PRACH time-domain resources and/or code resources, are shared resources.

Third Scenario

In this scenario, the indication information includes only second indication information. In this case, the second indication information may include a RAPID and an indication for the random access process type and the random access response type. That is, in this scenario, the first indication information may not be included, and all information is indicated through the second indication information.

Based on the abovementioned scenario, the second indication information is described below.

The second indication information may be an explicit indication manner.

For example, the second indication information may be a first indication field in the random access response. The first indication field may indicate the random access process type.

The second indication information may be a second indication field in a Media Access Control (MAC) subheader corresponding to the random access response. The second indication information is an indication field in the MAC subheader corresponding to the random access response, and the indication field may indicate the random access process type.

The second indication information may be an implicit indication manner.

For example, the second indication information is a third indication field in the MAC subheader corresponding to the random access response, the third indication field is configured to indicate an random access response length, and different random access response lengths correspond to different types of random access processes, or different random access response lengths correspond to different types of random access responses.

A first random access response length corresponds to a 2-step random access process type, and a second random access response length corresponds to a 4-step random access process type.

That is, a domain in the MAC subheader corresponding to the random access response indicates the random access response length, and different lengths represent different random access processes.

For example, two random access response lengths may be defined in the system: a length a corresponding to the 2-step random access process, and a length b corresponding to the 4-step random access process.

With respect to how the first processing unit 82 determines whether the random access response in the random access response message is responsive to the terminal device based on the above indication information, one of the following manners may be used.

First Manner

When the indication information only includes the first indication information, if it is determined according to the RAPID in the first indication information that the random access process type is consistent with a random access process type selected by the terminal device, it is determined that the random access response in the random access response message is a response for the terminal device.

This manner corresponds to the above first scenario. In the first scenario, only the first indication information is included, and the random access process type indicated by the first indication information is determined through correspondences between the RAPIDs and different random access process types. This manner may correspond to both the first and second manners for the first scenario. Different RAPIDs correspond to different PRACH resources, that is, the PRACH resources may be grouped and different RAPIDs correspond to different PRACH resource groups. Furthermore, the PRACH resources of different groups also correspond to different random access process types. Therefore, different random access process types are distinguished based on the RAPID in the first indication information.

Furthermore, it may be determined that the random access response in the random access response message is responsive to the terminal device only when the random access process type in the first indication information is the same as the random access process type selected by the terminal device.

It is also to be understood that the random access response message may at least include the indication information and the random access response.

Second Manner

When the indication information only includes the first indication information, if it is determined according to the RAPID in the first indication information that the random access response type corresponds to the random access process type selected by the terminal device, it is determined that the random access response in the random access response message is a response for the terminal device.

This manner corresponds to the above first scenario. In the first scenario, only the first indication information is included, and the random access process type indicated by the first indication information is determined through correspondences between the RAPIDs and different random access process types. This manner may correspond to both manners for the first scenario. Different RAPIDs correspond to different PRACH resources, that is, the PRACH resources may be grouped and different RAPIDs correspond to different PRACH resource groups. Furthermore, the PRACH resources of different groups also correspond to different random access process types. Therefore, different random access process types or different random access response types are distinguished based on the RAPIDs in the first indication information.

Furthermore, it may be determined that the random access response in the random access response message is responsive to the terminal device only when the random access response type in the first indication information corresponds to the random access process type selected by the terminal device.

Correspondences between different random access process types and different random access response types may be pre-configured by the system. The correspondences may be pre-configured to the terminal device by the network side, to ensure that configurations of the terminal device and the network side are identical.

It is also to be understood that the random access response message may at least include the indication information and the random access response.

Third Manner

When the RAPID in the first indication information is consistent with a RAPID sent by the terminal device, and the random access process type indicated by the second indication information is consistent with the random access process type selected by the terminal device, it is determined that the random access response in the random access response message is a response for the terminal device.

This manner corresponds to the above second scenario. That is, the RAPID in the first indication information is not configured to distinguish the random access process types and the random access response types, and is only configured to indicate a preamble Identifier (ID). In such case, it may be determined that the random access response in the random access response message is responsive to the terminal device only when the RAPIDs are consistent and the random access process type in the second indication information is the same as the random access process type selected by the terminal device.

Fourth Manner

When the RAPID in the first indication information is consistent with a RAPID sent by the terminal device, and the random access response type indicated by the second indication information is consistent with the random access process type selected by the terminal device, it is determined that the random access response in the random access response message is a response for the terminal device.

This manner corresponds to the above second scenario. That is, the RAPID in the first indication information is not configured to distinguish the random access process types and the random access response types, and is only configured to indicate a preamble Identifier (ID). In such case, it may be determined that the random access response in the random access response message is responsive to the terminal device only when the RAPIDs are consistent and the random access response type in the second indication information corresponds to the random access process type selected by the terminal device.

Fifth Manner

When the indication information only includes the second indication information, if the RAPID acquired from the second indication information is consistent with an RAPID sent by the terminal device and the random access process type indicated by the second indication information is consistent with the random access process type selected by the terminal device, it is determined that the random access response in the random access response message is a response for the terminal device.

This manner corresponds to the third scenario. That is, only the second indication information is sent, and random access process types or random access response types may not be distinguished through the RAPIDs. In such case, it may be determined whether the random access response is responsive to the terminal device when it is determined that the RAPID is the same as the random access preamble, and the random access process type is the same as that selected by the terminal.

Sixth Manner

When the indication information only includes the second indication information, the RAPID acquired from the second indication information is consistent with the RAPID sent by the terminal device and the random access response type indicated by the second indication information corresponds to the random access process type selected by the terminal device, it is determined that the random access response in the random access response message is a response for the terminal device.

This manner corresponds to the third scenario. That is, only the second indication information is sent, and the random access process types or the random access response types may not be distinguished through the RAPIDs. In such case, it may be determined whether the random access response is responsive to the terminal device when it is determined that the RAPID is the same as the random access preamble, and the random access response type corresponds to the random access process type selected by the terminal.

The random access preamble is sent by the terminal device on a pre-configured random access resource, and selected by the terminal device from at least two random access preambles.

The random access process type includes one of the 2-step random access process and the 4-step random access process.

The terminal device initiates different random access processes on different random access resources.

In NR, two random access manners are supported, i.e., a contention-based random access manner and a contention-free random access manner, as shown in FIG. 7.

The random access process may be triggered by the following events: initial access in an RRC idle state; an RRC connection re-establishment procedure; handover; UL or downlink data arrival in an RRC connected state when a UL synchronization state is a non-synchronized state; transmission in an RRC non-activated state; and a request for other System Information (SI).

The random access resources have correspondences with random access process types.

The random access resources include a time-frequency resource and/or a random access preamble.

It can be seen that, with the above solution, whether the random access response for the terminal device is received may be determined through the indication information in the random access response message sent to the terminal device by the network side. A random access type or a random access process type may be indicated in the indication information. Therefore, it is ensured that the terminal device can correctly receive the random access response conforming to a random access process type of the terminal device in a system where multiple types of random access processes exist.

The embodiments of the disclosure provide a network device, which includes a second communication unit.

The second communication unit is configured to send a random access response message to a terminal device.

The random access response message includes indication information, and the indication information may at least indicate different types of random access responses or indicate different types of random access processes.

It should also be pointed out that different types of random access responses correspond to different types of random access processes.

The following scenarios may be provided in the embodiment: a first scenario in a first manner and a second manner, a second scenario and a third scenario.

First Manner of the First Scenario

Regarding a condition that the indication information only includes first indication information, reference is made to the following descriptions.

The indication information includes the first indication information that is a Random Access Preamble Identifier (RAPID) in the random access response message. The RAPID is configured to indicate different types of random access processes or configured to indicate different types of random access responses.

In the scenario, the RAPID is different from an RAPID defined in the conventional art, and may be configured to indicate a random access process type or indicate different random access process responses. A specific processing manner is described as follows.

RAPIDs are grouped, and preambles are grouped. For example, there may be a group A and a group B. If a UE selects a 2-step random access process, when a Message 1 (msg1) is sent, a random access preamble is selected from the group A. If the UE selects a 4-step random access process, when the msg1 is sent, the preamble is selected from the group B.

Second Manner of the First Scenario

Regarding a condition that the indication information only includes first indication information, reference is made to the following descriptions.

The indication information includes the first indication information that is a Random Access Preamble Identifier (RAPID) in the random access response message. The RAPID is configured to indicate different types of random access processes or configured to indicate different types of random access responses.

In the scenario, the RAPID is different from an RAPID defined in the conventional art and may be configured to indicate a random access process type or indicate different random access process responses.

A difference of the second manner from the first manner is that, in the second manner, preambles may not be grouped, and it is only defined that different Physical Random Access Channel (PRACH) resources are adopted for a 2-step random access process and a 4-step random access process.

Specifically, PRACH resources corresponding to the 2-step random access process and the 4-step random access process may be grouped, but preambles of the PRACH resources may be identical. Of course, it is also to be understood that the PRACHs may not be grouped and it is only necessary to set that different types of random access processes correspond to different PRACH resources.

In such case, different types of RACH processes may be distinguished through the preambles. This is because UEs adopting different RACH processes may calculate different Random Access Radio Network Temporary Identities (RA-RNTIs) (the RA-RNTIs are calculated based on time-frequency positions of the PRACH resources) due to the grouping for the PRACH resources. Due to different RA-RNTIs, different RAR messages may be obtained.

In the second scenario, a random access process type or a random access response type is indicated through second indication information.

Specifically, the indication information further includes the second indication information configured to indicate different types of random access processes or configured to indicate different types of random access responses.

A difference from the second scenario from the first scenario is that, in the second scenario, the RAPID in the first indication information may not indicate the random access process type or the random access response type. That is, the first indication information only includes an ordinary RAPID.

It is to be noted that the ordinary RAPID in the second scenario is different from the RAPID in the first scenario, and the ordinary RAPID in the second scenario refers to that the PRACH resources may not be distinguished for different types of random access processes, that is, the PRACH resources, i.e., PRACH time-domain resources and/or code resources, are shared resources.

Third Scenario

In this scenario, the indication information includes only second indication information. In this case, the second indication information may include a RAPID and an indication for the random access process type and the random access response type. That is, in this scenario, no first indication information may be included, and all information is indicated through the second indication information.

Based on the abovementioned scenario, the second indication information is described below.

The second indication information may be an explicit indication manner.

For example, the second indication information may be a first indication field in the random access response. The first indication field may indicate the random access process type.

The second indication information may be a second indication field in a Media

Access Control (MAC) subheader corresponding to the random access response. The second indication information is an indication field in the MAC subheader corresponding to the random access response, and the indication field may indicate the random access process type.

The second indication information may be an implicit indication manner.

For example, the second indication information is a third indication field in the MAC subheader corresponding to the random access response, the third indication field is configured to indicate an random access response length, and different random access response lengths correspond to different types of random access processes, or different random access response lengths correspond to different types of random access responses.

A first random access response length corresponds to a 2-step random access process type, and a second random access response length corresponds to a 4-step random access process type.

That is, a domain in the MAC subheader corresponding to the random access response indicates the random access response length, and different lengths represent different random access processes.

For example, two random access response lengths may be defined in the system: a length a corresponding to the 2-step random access process, and a length b corresponding to the 4-step random access process.

The second communication unit is configured to receive different random access processes initiated by the terminal device on different random access resources.

The random access resources have correspondences with random access process types.

The random access resources include a time-frequency resource and/or a random access preamble.

It can be seen that, with the above solution, whether a random access response for the terminal device is received may be determined through the indication information in the random access response message sent to the terminal device by the network side, and a random access response type or a random access process type may be indicated in the indication information. Therefore, it is ensured that the terminal device can correctly receive the random access response conforming to a random access process type of the terminal device in a system where multiple types of random access processes exist

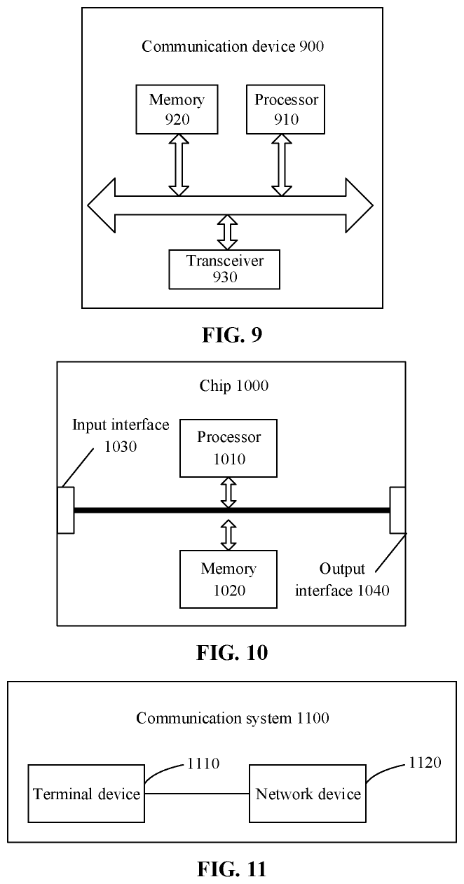

FIG. 9 is a schematic structural diagram of a communication device 900 according to an embodiment of the disclosure. The communication device 900 shown in FIG. 9 includes a processor 910, and the processor 910 may call and run a computer program in a memory to implement the method in the embodiments of the disclosure.

Optionally, as shown in FIG. 9, the communication device 900 may further include a memory 920. The processor 910 may call and run the computer program in the memory 920 to implement the method in the embodiments of the disclosure.

The memory 920 may be a separate device independent of the processor 910 and may also be integrated into the processor 910.

Optionally, as shown in FIG. 9, the communication device 900 may further include a transceiver 930, and the processor 910 may control the transceiver 930 to communicate with another device, specifically sending information or data to another device or receiving information or data sent by the another device.

The transceiver 930 may include a transmitter and a receiver. The transceiver 930 may further include an antenna, and the number of the antennas may be one or more.

Optionally, the communication device 900 may be a network device of the embodiment of the disclosure, and the communication device 900 may implement corresponding flows implemented by the network device in each method of the embodiments of the disclosure. For simplicity, elaborations are omitted herein.

Optionally, the communication device 900 may be a terminal device or network device of the embodiment of the disclosure, and the communication device 900 may implement corresponding flows implemented by the mobile terminal/terminal device in each method of the embodiments of the disclosure. For simplicity, elaborations are omitted herein.

FIG. 10 is a schematic structural diagram of a chip according to another embodiment of the disclosure. The chip 1000 shown in FIG. 10 includes a processor 1010, and the processor 1010 may call and run a computer program in a memory to implement the method in the embodiments of the disclosure.

Optionally, as shown in FIG. 10, the chip 1000 may further include the memory 1020. The processor 1010 may call and run the computer program in the memory 1020 to implement the method in the embodiments of the disclosure.

The memory 1020 may be a separate device independent of the processor 1010 and may also be integrated into the processor 1010.

Optionally, the chip 1000 may further include an input interface 1030. The processor 1010 may control the input interface 1030 to communicate with another device or chip, specifically acquiring information or data sent by the another device or chip.

Optionally, the chip 1000 may further include an output interface 1040. The processor 1010 may control the output interface 1040 to communicate with another device or chip, specifically outputting information or data sent by the other device or chip.

Optionally, the chip may be applied to the network device of the embodiments of the disclosure, and the chip may implement corresponding flows implemented by the network device in each method of the embodiments of the disclosure. For simplicity, elaborations are omitted herein.

Optionally, the chip may be applied to the terminal device of the embodiments of the disclosure, and the chip may implement corresponding flows implemented by the terminal device in each method of the embodiments of the disclosure. For simplicity, elaborations are omitted herein.

It is to be understood that the chip mentioned in the embodiment of the disclosure may also be called a system-level chip, a system chip, a chip system or a system on chip, etc.

FIG. 11 is a schematic block diagram of a communication system 1100 according to an embodiment of the disclosure. As shown in FIG. 11, a communication system 1100 includes a terminal device 1110 and a network device 1120.

The terminal device 1110 may be configured to realize corresponding functions realized by the terminal device in the above method, and the network device 1120 may be configured to realize corresponding functions realized by the network device in the above method. For simplicity, elaborations are omitted herein.

It is to be understood that the processor in the embodiment of the disclosure may be an integrated circuit chip and has a signal processing capability. In an implementation process, each step of the above method embodiments may be implemented by an integrated logical circuit of hardware in the processor or an instruction in a software form. The above processor may be a universal processor, a Digital Signal Processor (DSP), an Application Specific Integrated Circuit (ASIC), a Field Programmable Gate Array (FPGA) or another programmable logical device, a discrete gate or a transistor logical device and a discrete hardware component. Each method, operation and logical block diagram disclosed in the embodiments of the disclosure may be implemented or executed. The universal processor may be a microprocessor or the processor may also be any conventional processor and the like. The operations of the method disclosed in combination with the embodiments of the disclosure may be directly embodied to be executed and completed by a hardware decoding processor or executed and completed by a combination of hardware and software modules in the decoding processor. The software module may be located in a mature storage medium in this field such as a Random Access Memory (RAM), a flash memory, a Read-Only Memory (ROM), a Programmable ROM (PROM) or Electrically Erasable PROM (EEPROM) and a register. The storage medium is located in a memory, and the processor reads information in the memory, and implements the steps of the method in combination with hardware.

It can be understood that the memory in the embodiment of the disclosure may be a volatile memory or a nonvolatile memory, or may include both the volatile and nonvolatile memories. The nonvolatile memory may be a ROM, a PROM, an Erasable PROM (EPROM), an EEPROM or a flash memory. The volatile memory may be a RAM, and is used as an external high-speed cache. It is exemplarily but unlimitedly described that RAMs in various forms may be adopted, such as a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchlink DRAM (SLDRAM) and a Direct Rambus RAM (DR RAM). It is to be noted that the memory of a system and method described in the disclosure is intended to include, but not limited to, memories of these and any other proper types.

It is to be understood that the above memory is exemplarily but unlimitedly described. For example, the memory in the embodiments of the disclosure may also be an SRAM, a DRAM, an SDRAM, a DDR SDRAM, an ESDRAM, an SLDRAM and a DR RAM. That is, the memory in the embodiments of the disclosure is intended to include, but not limited to, memories of these and any other proper types.

The embodiments of the disclosure also provide a computer-readable storage medium, which is configured to store a computer program.

Optionally, the computer-readable storage medium may be applied to a network device in the embodiments of the disclosure, and the computer program enables a computer to execute corresponding flows implemented by the network device in each method of the embodiments of the disclosure. For simplicity, elaborations are omitted herein.

Optionally, the computer-readable storage medium may be applied to a mobile terminal/terminal device in the embodiments of the disclosure, and the computer program enables a computer to execute corresponding flows implemented by a mobile terminal/the terminal device in each method of the embodiments of the disclosure. For simplicity, elaborations are omitted herein.

The embodiments of the disclosure further provide a computer program product, which includes a computer program instruction.

Optionally, the computer program product may be applied to a network device in the embodiments of the disclosure, and the computer program instruction enables a computer to execute corresponding flows implemented by the network device in each method of the embodiments of the disclosure. For simplicity, elaborations are omitted herein.

Optionally, the computer program product may be applied to a mobile terminal/terminal device in the embodiments of the disclosure, and the computer program instruction enables the computer to execute corresponding flows implemented by the mobile terminal/terminal device in each method of the embodiments of the disclosure. For simplicity, elaborations are omitted herein.

The embodiments of the disclosure further provide a computer program.

Optionally, the computer program may be applied to a network device in the embodiments of the disclosure, and the computer program runs in a computer to enable the computer to execute corresponding flows implemented by the network device in each method of the embodiments of the disclosure. For simplicity, elaborations are omitted herein.

Optionally, the computer program may be applied to a mobile terminal/terminal device in the embodiments of the disclosure, and the computer program runs in the computer to enable the computer to execute corresponding flows implemented by the mobile terminal/terminal device in each method of the embodiments of the disclosure. For simplicity, elaborations are omitted herein.

Those of ordinary skill in the art may realize that the units and algorithm steps of each example described in combination with the embodiments disclosed in the disclosure may be implemented by electronic hardware or a combination of computer software and the electronic hardware. Whether these functions are executed in a hardware or software manner depends on specific applications and design constraints of the technical solutions. Professionals may realize the described functions for each specific application by use of different methods, but such realization shall fall within the scope of the disclosure.

Those skilled in the art may clearly learn about that regarding specific operation processes of the system, device and unit described above, reference may be made to the corresponding processes in the above method embodiment, and elaborations are omitted herein for convenient and brief description.

In some embodiments provided by the disclosure, it is to be understood that the disclosed system, device and method may be implemented in another manner. For example, the device embodiment described above is only schematic. For example, division of the units is only logic function division, and other division manners may be adopted during practical implementation. For example, multiple units or components may be combined or integrated into another system, or some characteristics may be neglected or not executed. In addition, coupling or direct coupling or communication connection between displayed or discussed components may be indirect coupling or communication connection implemented through some interfaces, the device or the units, and may be electrical and mechanical or in other forms.

The units described as separate parts may or may not be physically separated, and parts displayed as units may or may not be physical units, and namely may be located in the same place, or may also be distributed to multiple network units. A part or all of the units may be selected to achieve the purpose of the solutions of the embodiments according to a practical requirement.

In addition, each functional unit in each embodiment of the disclosure may be integrated into a processing unit, each unit may also physically exist independently, and two or more than two units may also be integrated into a unit.

When being implemented in form of software functional unit and sold or used as an independent product, the function may also be stored in a computer-readable storage medium. Based on such an understanding, an essential part of the technical solutions in the disclosure, a part of the technical solutions making contributions to the prior art, or a part of the technical solutions may be embodied in a form of a software product. The computer software product is stored in a storage medium and includes several instructions configured to enable a computer device (which may be a personal computer, a server, a network device or the like) to execute all or a part of the operations of the method in each embodiment of the disclosure. The above-mentioned storage medium includes: various media capable of storing program codes such as a U disk, a mobile hard disk, a Read-Only Memory (ROM), a Random Access Memory (RAM), a magnetic disk and an optical disk.

The foregoing is only the specific embodiments of the disclosure, and the scope of protection of the disclosure is not limited thereto. Any variations or replacements easily appreciated by those skilled in the art within the technical scope disclosed by the disclosure shall fall within the scope of protection of the disclosure. Therefore, the scope of protection of the disclosure shall conform to the scope of protection of the claims.

1. A method for random access, applied to a terminal device and comprising:
receiving a random access response message sent by a network side; and
determining whether a random access response in the random access response message is responsive to the terminal device based on indication information in the random access response message,
wherein the indication information is able to at least indicate different types of random access responses or indicate different types of random access processes.

2. The method of claim 1, wherein the indication information comprises:
first indication information that is a random access preamble identifier (RAPID) in the random access response message, the RAPID being configured to indicate different types of random access processes or configured to indicate different types of random access responses.

3. The method of claim 1, wherein the indication information further comprises:
second indication information configured to indicate different types of random access processes or configured to indicate different types of random access responses.

4. The method of claim 3, wherein
the second indication information is a first indication field in the random access response; or
the second indication information is a second indication field in a Media Access Control (MAC) subheader corresponding to the random access response; or
the second indication information is a third indication field in a Media Access Control (MAC) subheader corresponding to the random access response, and the third indication field is configured to indicate an random access response length, different random access response lengths corresponding to different types of random access processes, or different random access response lengths corresponding to different types of random access responses.

5. The method of claim 4, wherein a first random access response length corresponds to a 2-step random access process type, and a second random access response length corresponds to a 4-step random access process type.

6. The method of claim 1, wherein the determining whether the random access response in the random access response message is responsive to the terminal device based on the indication information in the random access response message comprises one of:
when the indication information only comprises first indication information, in response to that it is determined according to a random access preamble identifier (RAPID) in the first indication information that a random access process type is consistent with a random access process type selected by the terminal device, determining that the random access response in the random access response message is a response for the terminal device;
when the indication information only comprises the first indication information, in response to that it is determined according to the RAPID in the first indication information that a random access response type corresponds to a random access process type selected by the terminal device, determining that the random access response in the random access response message is a response for the terminal device;
when the RAPID in the first indication information is consistent with a RAPID sent by the terminal device, and a random access process type indicated by the second indication information is consistent with a random access process type selected by the terminal device, determining that the random access response in the random access response message is a response for the terminal device;
when the RAPID in the first indication information is consistent with the RAPID sent by the terminal device, and a random access response type indicated by the second indication information corresponds to the random access process type selected by the terminal device, determining that the random access response in the random access response message is a response for the terminal device;
when the indication information only comprises the second indication information, a RAPID acquired from the second indication information is consistent with the RAPID sent by the terminal device and the random access process type indicated by the second indication information is consistent with the random access process type selected by the terminal device, determining that the random access response in the random access response message is a response for the terminal device; and
when the indication information only comprises the second indication information, the RAPID acquired from the second indication information is consistent with the RAPID sent by the terminal device and the random access response type indicated by the second indication information corresponds to the random access process type selected by the terminal device, determining that the random access response in the random access response message is a response for the terminal device.

7. The method of claim 6, wherein a random access preamble is sent by the terminal device on a pre-configured random access resource and is selected by the terminal device from at least two random access preambles.

8. The method of claim 1, further comprising:
initiating, by the terminal device, different random access processes on different random access resources.

9. The method of claim 8, wherein the random access resources have correspondences with the random access process types, and
the random access resources comprise at least one of a time-frequency resource or a random access preamble.

10. A terminal device, comprising:
a processor;
a memory configured to store a computer program; and
a transceiver,
wherein the processor is configured to call and run the computer program stored in the memory to control the transceiver to receive a random access response message sent by a network side; and
the processor is configured to call and run the computer program stored in the memory to determine whether a random access response in the random access response message is responsive to the terminal device based on indication information in the random access response message,
wherein the indication information is able to at least indicate different types of random access responses or indicate different types of random access processes.

11. The terminal device of claim 10, wherein the indication information comprises:
first indication information that is a random access preamble identifier (RAPID) in the random access response message, the RAPID being configured to indicate different types of random access processes or configured to indicate different types of random access responses.

12. The terminal device of claim 10, wherein the indication information further comprises:
second indication information configured to indicate different types of random access processes or configured to indicate different types of random access responses.

13. The terminal device of claim 12, wherein the second indication information is a first indication field in the random access response.

14. The terminal device of claim 12, wherein the second indication information is a second indication field in a Media Access Control (MAC) subheader corresponding to the random access response.

15. The terminal device of claim 12, wherein the second indication information is a third indication field in a Media Access Control (MAC) subheader corresponding to the random access response, and
the third indication field is configured to indicate an random access response length, different random access response lengths corresponding to different types of random access processes, or different random access response lengths corresponding to different types of random access responses.

16. The terminal device of claim 15, wherein a first random access response length corresponds to a 2-step random access process type, and a second random access response length corresponds to a 4-step random access process type.

17. The terminal device of claim 10, wherein the processor is configured to call and run the computer program stored in the memory to implement one of following operations:
when the indication information only comprises first indication information, in response to that it is determined according to a random access preamble identifier (RAPID) in the first indication information that a random access process type is consistent with a random access process type selected by the terminal device, determining that the random access response in the random access response message is a response for the terminal device;
when the indication information only comprises the first indication information, in response to that it is determined according to the RAPID in the first indication information that a random access response type corresponds to a random access process type selected by the terminal device, determining that the random access response in the random access response message is a response for the terminal device;
when the RAPID in the first indication information is consistent with a RAPID sent by the terminal device, and a random access process type indicated by the second indication information is consistent with a random access process type selected by the terminal device, determining that the random access response in the random access response message is a response for the terminal device;
when the RAPID in the first indication information is consistent with the RAPID sent by the terminal device, and a random access response type indicated by the second indication information corresponds to the random access process type selected by the terminal device, determining that the random access response in the random access response message is a response for the terminal device;
when the indication information only comprises the second indication information, a RAPID acquired from the second indication information is consistent with the RAPID sent by the terminal device and the random access process type indicated by the second indication information is consistent with the random access process type selected by the terminal device, determining that the random access response in the random access response message is a response for the terminal device; and
when the indication information only comprises the second indication information, the RAPID acquired from the second indication information is consistent with the RAPID sent by the terminal device and the random access response type indicated by the second indication information corresponds to the random access process type selected by the terminal device, determining that the random access response in the random access response message is a response for the terminal device.

18. The terminal device of claim 17, wherein a random access preamble is sent by the terminal device on a pre-configured random access resource and is selected by the terminal device from at least two random access preambles.

19. The terminal device of claim 10, wherein the processor is configured to call and run the computer program stored in the memory to initiate different random access processes on different random access resources.

20. The terminal device of claim 19, wherein the random access resources have correspondences with the random access process types, and
the random access resources comprise at least one of a time-frequency resource or a random access preamble.
